(19) United States
(12) Patent Application Publication
(10) Pub. No.: US 2026/0367974 A1
(43) Pub. Date: Nov. 19, 2026

(54) System and Operation History Management Method

(71) Applicant: Hitachi, Ltd., Chiyoda-ku, Tokyo (JP)

(72) Inventors: Kenichi SHIMBO, Tokyo (JP); Yutaka UEMATSU, Tokyo (JP); Tadanobu TOBA, Tokyo (JP); Takumi UEZONO, Tokyo (JP)

(21) Appl. No.: 19/143,967

(22) PCT Filed: Oct. 3, 2023
(86) PCT No.: PCT/JP2023/036064

§ 371 Date: Jun. 27, 2025

(30) Foreign Application Priority Data
Jan. 6, 2023 (JP) 2023-001070

(51) Int. Cl. G06F 9/50

(52) U.S. Cl. CPC G06F 9/5016

(57) ABSTRACT

An operation history of an electronic device or the like can be managed using state data in which a communication amount is further reduced.

A memory resource of an edge-side processor system stores threshold information and an operation history generation program. When an operating environment of the electronic device exceeds a threshold, a processor of the edge-side processor system transmits, to a server-side processor system, operation history information including a threshold ID. A memory resource of the server-side processor system stores a cumulative failure rate calculation program and an operation history management program. A processor of the server-side processor system calculates a cumulative failure rate based on a cumulative operation time under each of operating environments to a total operation time of the electronic device for each of threshold classifications corresponding to the threshold ID, estimates a remaining life based on a cumulative failure rate, and generates operation history management information including the remaining life and the cumulative operation time under a stress environment.

### TECHNICAL FIELD

The present invention relates to a system and an operation history management method. The invention claims the priority of Japanese Patent Application No. 2023-001070 filed on Jan. 6, 2023, and the contents described in the application are incorporated into the present application by reference in the designated country where incorporation by reference of literatures is permitted.

### BACKGROUND ART

In a technical field of handling an electronic device, expansion of secondary usage and reuse of electronic devices (components) for the purpose of resource optimization is assumed in achieving circular economy. In recent years, for the purpose of improving maintainability and support during a performance life (insufficient performance, low power consumption), electronic devices or electronic components mounted on electronic devices are modularized, and replacement services in units of modules are developed.

For this reason, it is expected that the electronic devices and the electronic components will be reused as maintenance components or secondarily used in separate devices in the future. Therefore, from the viewpoint of product performance and life, it is considered important for the electronic device or the like to grasp and manage an operation history including an environmental influence (stress influence) such as how long and under what environment the electronic device or the like has operated throughout a life cycle, and to share information between business operators.

On the other hand, for example, in an open industrial system in which an enormous number of edge devices owned by a plurality of business operators or a new value is generated by each piece of data having a connection, there is a problem that a data amount or communication cost becomes enormous when state data, sensor data, or the like of a device is constantly collected in real time in order to grasp and manage an operation history of an electronic device or the like to be managed.

PTL 1 discloses a technique of acquiring state data output from a device and obtaining a cumulative failure rate of a designated component. Specifically, PTL 1 discloses that “an inventory management system includes a plurality of devices, an information management device to which the plurality of devices are connected, and an information processing device. The information processing device calculates a total sum of cumulative failure rates which is a value obtained by adding a cumulative failure rate at a certain time point, taking into account an acceleration due to driving conditions, for all designated components having the same specifications used in the plurality of devices, relative to a standard cumulative failure rate under standard driving conditions for each of the designated components having the same specifications used in the plurality of devices, and derives an appropriate inventory quantity of the designated components based on the calculated total sum of the cumulative failure rates”.

### CITATION LIST

### Patent Literature

PTL 1: JP2018-142256A

### SUMMARY OF INVENTION

### Technical Problem

In the system described in PTL 1, data indicating a driving state is acquired from the device, and the inventory quantity of the component is determined based on the cumulative failure rate calculated using the acquired data. However, the system in PTL 1 assumes that the state data is acquired from a device in a factory in a closed environment. Therefore, in the system in PTL 1, a problem that the data amount and the communication cost become enormous in collecting the state data of the device is not considered.

The invention has been made in view of the above problems, and an object of the invention is to manage an operation history of an electronic device or the like using state data in which a communication amount is further reduced.

### Solution to Problem

The present application includes a plurality of units for solving at least a part of the above problems, and examples thereof are as follows. A system according to an aspect of the invention for solving the above problem includes: an edge-side processor system that is mounted on an edge device and that includes a processor and a memory resource; and a server-side processor system that is communicable with the edge-side processor system, that is mounted on a server computer, and that includes a processor and a memory resource. The memory resource of the edge-side processor system stores at least threshold information in which a threshold corresponding to a predetermined deterioration factor that shortens a period until a failure of an electronic device or an electronic component is registered, and an operation history generation program, by executing the operation history generation program, the processor of the edge-side processor system generates operation history information including a threshold ID for identifying the threshold when an operating environment of the electronic device or the electronic component exceeds the threshold, and transmits the generated operation history information to the server-side processor system, the memory resource of the server-side processor system stores at least a cumulative failure rate calculation program and an operation history management program, by executing the cumulative failure rate calculation program, the processor of the server-side processor system calculates, for each threshold classification corresponding to the threshold ID, a cumulative operation time under each of operating environments to a total operation time of the electronic device or the electronic component, calculates a cumulative failure rate of the electronic device or the electronic component based on the cumulative operation time, and estimates a remaining life of the electronic device or the electronic component based on the cumulative failure rate and a product life, and by executing the operation history management program, the processor of the server-side processor system generates operation history management information including the remaining life and the cumulative operation time under at least a stress environment among the operating environments.

### ADVANTAGEOUS EFFECTS OF INVENTION

According to the invention, it is possible to manage an operation history of an electronic device or the like by using state data in which a communication amount is further reduced.

### BRIEF DESCRIPTION OF DRAWINGS

FIG. 1 is a diagram showing an example of a schematic configuration of an edge-side processor system.

FIG. 2 is a diagram showing an example of threshold information.

FIG. 3 is a diagram showing an example of a schematic configuration of a server-side processor system.

FIG. 4 is a diagram showing a schematic example of system processing.

FIG. 5 is a flowchart showing an example of generation processing of operation history information.

FIG. 6 (a) of FIG. 6 is a diagram showing an example of the operation history information; and (b) of FIG. 6 is a diagram showing an example of a transmission history of the operation history information.

FIG. 7 is a diagram showing an example of a relationship between an event occurrence timing and a change in an operating environment.

FIG. 8 is a flowchart showing an example of generation processing of operation history management information.

FIG. 9 is a diagram showing an example of specific calculation contents in the generation processing of the operation history management information.

FIG. 10 (a) of FIG. 10 is a diagram showing an estimation graph of a remaining life within a product life; and (b) of FIG. 10 is a diagram showing an estimation graph of the remaining life after the product life.

FIG. 11 shows an example of the operation history management information.

FIG. 12 is a diagram showing an example of a transmission history of operation history information according to a second embodiment.

FIG. 13 (a) of FIG. 13 is a diagram showing an example of a relationship between an event occurrence timing and a change in an operating environment when a deterioration factor is a temperature; and (b) of FIG. 13 is a diagram showing an example of the relationship between the event occurrence timing and the change in the operating environment when the deterioration factor is a vibration.

FIG. 14 is a diagram showing an example of specific calculation contents of a cumulative failure rate in the generation processing of the operation history management information according to the second embodiment.

FIG. 15 is a diagram showing an example of feature value calculation processing.

FIG. 16 is a diagram showing an example of a service form for a fleet business operator and a used vehicle dealer.

FIG. 17 is a diagram showing an example of a service form for a reuse and secondary use vendor.

FIG. 18 is a diagram showing an example of a service form for a manufacturing company (OEM) or the reuse and secondary use vendor.

### DESCRIPTION OF EMBODIMENTS

Hereinafter, each of embodiments of the invention will be described with reference to the drawings.

### Schematic Configuration of System

The present system includes a processor system of a server computer (hereinafter, may be referred to as a “server-side processor system”) and a processor system (hereinafter, may be referred to as an “edge-side processor system”) included in an edge device (for example, a moving body such as an automobile or a railway, a home appliance, or a medical device) on which an electronic device or an electronic component is mounted. The server-side processor system and the edge-side processor system are communicably connected to each other via a predetermined communication network (for example, the Internet, a local area network (LAN), or a wide area network (WAN)).

The present system is used for grasping and manage the operation history of the electronic device and the electronic component mounted on the edge device, including the environmental influence, such as how long the electronic device is operating in a standard environment or a stress environment.

Specifically, the present system calculates a cumulative failure rate of the electronic device or the like based on a cumulative operation time in each environment such as a normal environment or a stress environment. In addition, the present system calculates a remaining life of the electronic device or the like based on the calculated cumulative failure rate and a product life, and generates operation history management information in which an operation time and the remaining life under each environment are registered.

More specifically, the edge-side processor system detects an operating environment of the electronic device or the like (for example, an electronic device or an ambient temperature of the electronic device) based on sensor information (a sensor value indicating a temperature) acquired from a sensor (for example, a temperature sensor) connected to the electronic device or the like. When the operating environment of the electronic device crosses (exceeds) a predetermined threshold, that is, when a threshold classification corresponding to the operating environment changes, the edge-side processor system generates operation history information including information on the changed threshold classification and transmits the operation history information to the server-side processor system.

The server-side processor system calculates a ratio of the cumulative operation time for each operating environment (for each threshold classification) to a total operation time of the electronic device or the like based on the acquired operation history information, and calculates the cumulative failure rate of the electronic device or the like using the ratio.

The server-side processor system calculates the remaining life of the electronic device or the like based on a comparison between the product life and the cumulative failure rate. The server-side processor system generates operation history management information in which the cumulative operation time and the remaining life of each of the standard environment and the stress environment are registered in association with each other.

The present system generates a feature value using the operation history management information fed back to the edge side processor system and the latest operation history information, and detects tampering of the operation history management information in the edge-side processor system based on a comparison between a feature value calculated by the edge-side processor system and a feature value calculated by the server-side processor system.

According to the present system, it is possible to manage the operation history of the electronic device or the like using the state data in which the communication amount is further reduced. In particular, the operation history information transmitted from the edge-side processor system to the server-side processor system is simplified by representing the operating environment of the electronic device or the like using the threshold classification, and the data amount thereof is reduced. Since the operation history information is transmitted to the server-side processor system only at the time of generation, the number of communications is reduced. Therefore, in the present system, it is possible to contribute to a reduction in the communication amount between the edge device and the server computer and the accompanying communication cost.

Since the present system can detect the tampering of the operation history, it can contribute to prevention of tampering of the operation history that may occur when an owner of the edge device equipped with the electronic device is changed, for example, at the time of secondary use or reuse.

Hereinafter, each configuration and processing of the edge-side processor system and the server-side processor system will be described in detail. The edge device on which the edge-side processor system is mounted is not particularly limited, and the following description will be made by taking a case of an automobile as an example.

### Configuration of Edge-Side Processor System 100

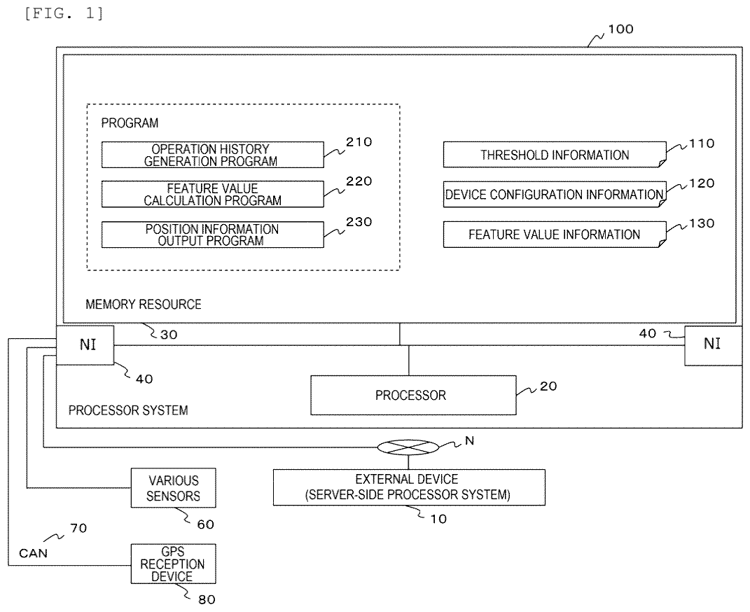

FIG. 1 is a diagram showing an example of a schematic configuration of the edge-side processor system 100. The edge-side processor system 100 is a processor system that transmits various types of information (including operation history information) to an external device 10 based on information communication with the external device 10 (including the server-side processor system).

### External Device 10 (Including Server-Side Processor System)

The external device 10 as viewed from the edge-side processor system 100 includes the server-side processor system. The external device 10 collects information to be used for processing executed by the edge-side processor system 100 and transmits the information to the processor system 100. The external device 10 acquires information transmitted from the edge-side processor system 100 and executes various types of processing using the information.

Details of Edge-Side Processor System 100 The edge-side processor system 100 executes various types of processing such as generation processing of the operation history information by a processor 20 reading various programs and information stored in a memory resource 30.

As an example, the edge-side processor system 100 is implemented by being mounted on an electronic device such as an electronic control unit (ECU) or a chip (electronic component) built in the ECU. That is, the edge-side processor system 100 is incorporated in the electronic device or the electronic component to use resources such as a processor and a memory included in the electronic device as the processor 20 and the memory resource 30 of the edge-side processor system 100.

An implementation destination of the edge-side processor system 100 is not particularly limited. For example, the edge-side processor system 100 can acquire information output from various electronic devices, electronic components, and sensors (for example, a temperature sensor and the like) mounted on the edge device, and may be mounted on another ECU, a built-in chip, a unit (for example, including a communication unit), or a device of the another ECU capable of transmitting the operation history information generated by the edge-side processor system 100 to the server-side processor system.

Alternatively, the edge-side processor system 100 may be implemented as a processor system having independent processors and memory resources in the edge device, instead of being implemented in an electronic device or the like. Hereinafter, a case in which the edge-side processor system 100 is implemented in an ECU (electronic device) will be described as an example.

As shown in FIG. 1, the edge-side processor system 100 includes the processor 20, the memory resource 30, and a network interface device (NI) 40. The edge-side processor system 100 may include a user interface device (UI) as in the server-side processor system.

The processor 20 is a calculation device that reads various programs stored in the memory resource 30 and executes processing corresponding to each program. Examples of the processor 20 include a micro-processor, a central processing unit (CPU), a graphics processing unit (GPU), a field programmable gate array (FPGA), or another semiconductor device that can perform calculation.

The memory resource 30 is a storage device that stores various types of information. Specifically, the memory resource 30 is a nonvolatile or volatile storage medium such as a random access memory (RAM) or a read only memory (ROM). The memory resource 30 may be, for example, a rewritable storage medium such as a flash memory, a hard disk, or a solid state drive (SSD), a universal serial bus (USB) memory, a memory card, or a hard disk.

The NI 40 is a communication device that performs information communication with the external device 10. The NI 40 performs information communication with the external device 10 via a predetermined communication network N. The NI 40 performs information communication with various sensors 60. The NI 40 performs information communication with a global positioning system (GPS) reception device 80 via a controller area network (CAN) 70, for example.

When the edge device includes a communication unit, the NI 40 performs the information communication with the external device 10 via the communication unit. It is assumed that the information communication between the edge-side processor system 100 and the external device 10 is executed via the NI 40 unless otherwise identified.

A part or all of configurations, functions, processing methods, and the like of the edge-side processor system 100 may be implemented by hardware by, for example, designing with an integrated circuit. In the edge-side processor system 100, a part or all of the functions may be implemented by software or may be implemented by cooperation of software and hardware. The edge-side processor system 100 may use hardware having a fixed circuit, or may use hardware capable of changing at least a part of the circuit.

In addition, when the edge-side processor system 100 includes a UI 51, the edge-side processor system 100 can also implement the system by a user (operator) performing a part or all of the functions and processing implemented by each program. The edge-side processor system 100 may entrust a part of output processing to a user and a part of input processing from the user to a processor system outside the system (referred to as an external processor system) such as a smartphone or tablet instead of the processor system. In such a case, the edge-side processor system 100 (or the processor 20 and program) may perform the following in order to execute other parts of each processing or program.

Instead of the output to the user using the UI 51, data necessary for the output to the user is transmitted to the external processor system via the NI 40. As an example of the data, data to be output and data for generating output data in another processor system may be considered, and a program or Web data describing processing of outputting to the user by the external processor system may be used.

The edge-side processor system 100 receives data indicating a user input or an operation from the external processor system via the NI 40 instead of receiving an input or an operation from the user using the UI 51. From another perspective, the meaning of outputting data to the user may not only include the edge-side processor system 100 itself outputting the data, and may also include having another entity other than the processor system 100 output the data (using the processor system 100 to perform the output). The meaning of input or operation reception from the user may include not only direct output or reception to and from the user of the edge-side processor system 100 but also indirect reception by the edge-side processor system 100.

The database and various types of information in the memory resource 30 described below may have a data structure other than a file or the like or a database as long as it is an area capable of storing data. One program may also serve as a plurality of programs. In addition, a plurality of programs may serve as one program. That is, one or more programs may perform the processing of each shown program.

The program executed by the edge-side processor system 100 may be stored in a nonvolatile storage medium readable by the processor system 100. The program stored in the nonvolatile storage medium may be directly read by the edge-side processor system 100, or a processor system for program distribution may read the program from the medium and then transmit (distribute) the program from the processor system for program distribution to the edge-side processor system 100. As an example of the nonvolatile storage medium, a nonvolatile memory described as the memory resource 30 is considered as an example, and other optical disk media may be used.

### Threshold Information 110

The threshold information 110 is information in which a threshold for classifying an operating environment of an electronic device is registered. Specifically, the threshold information 110 includes information such as a threshold and a polarity indicating a change of the operating environment with respect to the threshold. More specifically, the threshold information 110 includes a plurality of records in which a threshold ID, a parameter, a threshold, and a polarity are associated with each other.

The threshold information 110 is of a type corresponding to each of predetermined deterioration factors (for example, temperature and vibration) that accelerate a period until the electronic device fails. Hereinafter, a case in which the deterioration factor is a temperature will be described as an example.

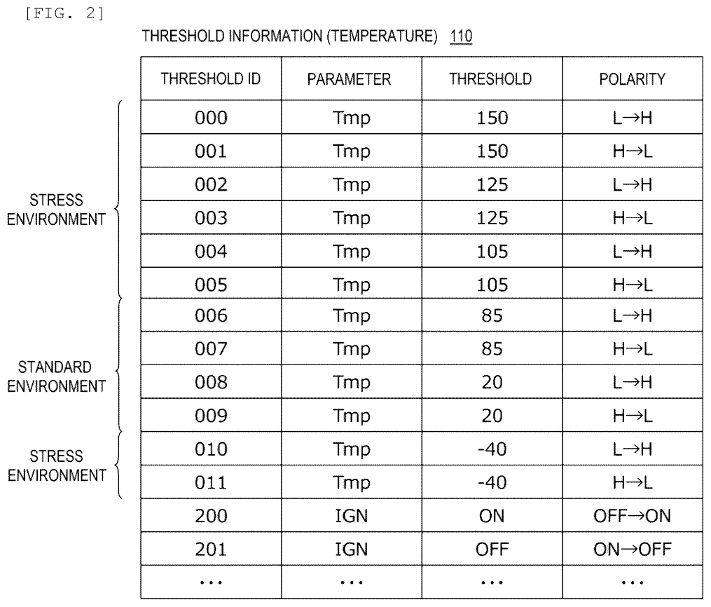

FIG. 2 is a diagram showing an example of the threshold information 110. The threshold ID is identification information indicating a threshold classification identified by the threshold and the polarity, and is also information identifying the operating environment of the electronic device. That is, the operating environment of the electronic device is identified by the threshold ID. A parameter is information indicating a deterioration factor, and “Tmp” indicating a temperature is registered in the example.

The threshold indicates a boundary value for classifying each operating environment. In the example, the temperature in the ECU corresponds to each threshold. The polarity is information indicating a change direction of the operating environment with respect to the threshold. For example, “L→H” indicates that the operating environment is changed from Low (less than the threshold) to High (equal to or greater than the threshold) with respect to a certain threshold, and “H→L” indicates the opposite.

Here, taking a record associated with the threshold ID “000” as an example, the record indicates that the operating environment of the electronic device is changed from less than 150 °C to 150 °C or higher.

In the threshold information 110, a threshold ID (threshold ID “200” or “201”) indicating that a power supply of the edge device (automobile) on which the electronic device is mounted is changed from an OFF state to an ON state or from the ON state to the OFF state is also registered. “IGN” (Ignition) of the parameter indicates a power supply of the edge device.

In the electronic device (ECU) of the present example, the operating environment corresponding to the threshold IDs “006” to “009” corresponds to the standard environment, and the operating environment corresponding to the threshold IDs “005” to “000” indicating a temperature range higher than the threshold IDs and the threshold IDs “010” to “011” indicating a temperature range lower than the threshold IDs corresponds to a stress environment.

The threshold information 110 is not limited to such a data structure, and may include at least information on the threshold classification, the threshold, and the polarity.

### Device Configuration Information 120

The device configuration information 120 is information related to a configuration of an electronic device or the like mounted on the edge device. Specifically, in the device configuration information 120, various pieces of information on the electronic device such as information (for example, a device ID) for identifying the electronic device mounted on the edge device and a product life of each component device are registered. The device configuration information 120 may include, for example, a vehicle ID or a vehicle identification number (VIN) of the automobile that is the edge device.

### Feature Value Information 130

The feature value information 130 is, for example, a feature value generated using the operation history management information and the operation history information by stream encryption or a one-way hash function. Details of processing related to the feature value will be described later in a third embodiment.

Operation History Generation Program 210 The operation history generation program 210 performs generation processing of the operation history information. Specifically, the operation history generation program 210 acquires sensor information (a sensor value indicating a temperature) from the temperature sensor, and determines whether the operating environment of the electronic device exceeds the threshold by comparing the latest sensor value with the previous sensor value using the threshold information 110. When it is determined that the operating environment exceeds the threshold, the operation history generation program 210 generates the operation history information including a threshold ID corresponding to the operating environment after the change and transmits the operation history information to the server-side processor system.

Also, when the sensor information (a sensor value indicating that the ignition is changed from the OFF state to the ON state or from the ON state to the OFF state) is acquired from a sensor that detects ON/OFF of the ignition of the automobile, the operation history generation program 210 generates the operation history information including a corresponding threshold ID and transmits the operation history information to the server-side processor system. Details of the generation processing of the operation history information will be described later.

### Feature Value Calculation Program 220

The feature value calculation program 220 calculates a feature value using the operation history information. Specifically, the feature value calculation program 220 calculates the feature value using the operation history management information and the operation history information by stream encryption or a one-way hash function. The feature value calculation program 220 stores the calculated feature value in the memory resource 30 and transmits the feature value to the server-side processor system. Details of feature value calculation processing will be described later in a third embodiment.

### Position Information Output Program 230

The position information output program 230 outputs position information of the edge device. Specifically, the position information output program 230 identifies a current position of the vehicle using, for example, information output from the GPS reception device 80, and transmits the current position to the server-side processor system. Details of the processing will be described in a fourth embodiment to be described later.

An example of the configuration of the edge-side processor system 100 is described above.

### Configuration of Server-Side Processor System 300

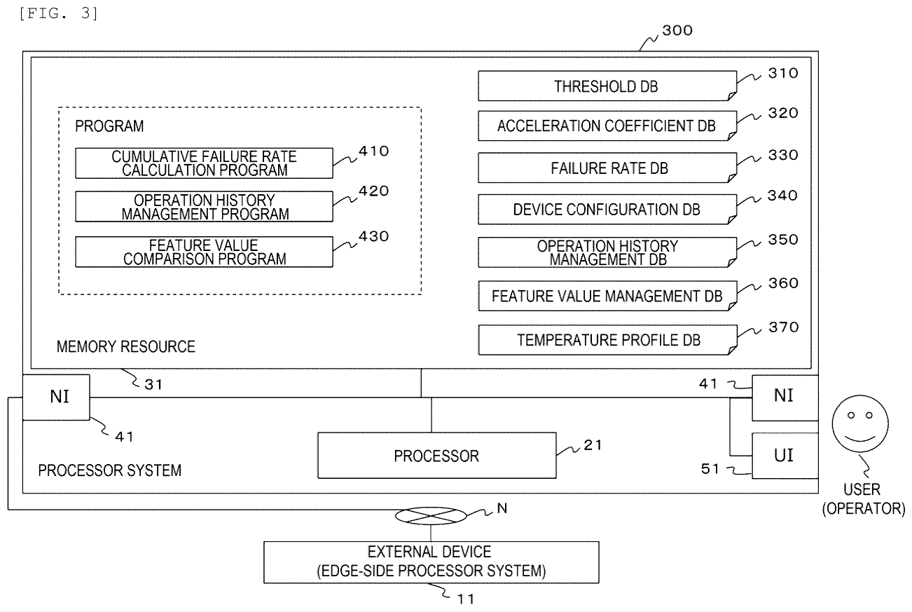

FIG. 3 is a diagram showing an example of a schematic configuration of the server-side processor system 300. The server-side processor system 300 is a server device that provides various services (including a cloud service) to the external device 11 based on information communication with the external device 11 (including the edge-side processor system 100 in the present embodiment).

### External Device 11 (Including Edge-Side Processor System 100)

The external device 11 as viewed from the server-side processor system 300 includes the edge-side processor system 100. The external device 11 transmits, to the processor system, information to be used for processing executed by the server-side processor system 300. The external device 11 acquires information output from the server-side processor system 300 and executes various types of processes using the information.

### Details of Server-Side Processor System 300

In the server-side processor system 300, the processor 21 reads various programs and information stored in the memory resource 301 to execute the generation processing of the operation history management information.

The server-side processor system 300 is, for example, a computer such as a server computer, a cloud server, a personal computer, a tablet terminal, or a smartphone, and is a system including at least one or more of these computers.

As shown, the server-side processor system 300 includes the processor 21, the memory resource 31, a NI 41, and the UI 51.

Since the processor 21, the memory resource 31, and the NI 41 are the same as those of the edge-side processor system 100, a detailed description thereof will be omitted. The UI 51 is an input device that inputs an instruction of a user (operator) to the server-side processor system 300 and an output device that outputs information generated by the server-side processor system 300. Examples of the input device include a keyboard, a touch panel, a pointing device such as a mouse, and a voice input device such as a microphone.

Examples of the output device include a display, a printer, and a voice synthesis device. Unless otherwise identified in the following description, it is assumed that a user operation (for example, input and output of information and a processing execution instruction) on the server-side processor system 300 is executed via the UI 51.

A part or all of configurations, functions, processing methods, and the like of the server-side processor system 300 may be implemented by hardware by, for example, designing with an integrated circuit. In the server-side processor system 300, a part or all of the functions may be implemented by software or may be implemented by cooperation of software and hardware. The server-side processor system 300 may use hardware having a fixed circuit, or may use hardware capable of changing at least a part of the circuit.

The server-side processor system 300 can also implement the system by a user (operator) performing a part or all of the functions and processing implemented by each program.

A database and various types of information in the memory resource 31 described below may have a data structure other than a file or the like or a database as long as the data structure has an area where data can be stored. One program may also serve as a plurality of programs. In addition, a plurality of programs may serve as one program. That is, one or more programs may perform the processing of each shown program.

The program executed by the server-side processor system 300 may be stored in a nonvolatile storage medium readable by the processor system 300. The program stored in the nonvolatile storage medium may be directly read by the server-side processor system 300, or a processor system for program distribution may read the program from the medium and then transmit (distribute) the program from the processor system for program distribution to the server-side processor system 300. As an example of the nonvolatile storage medium, a nonvolatile memory described as the memory resource 30 is considered as an example, and other optical disk media may be used.

### Threshold DB 310

The threshold database (DB) 310 is a database that stores threshold information (the threshold information 110) corresponding to various deterioration factors that accelerate a period until a failure of the electronic device. Since a data structure of the threshold information 110 stored in the database 310 is the same as that of the threshold information 110 shown in FIG. 2, the detailed description thereof will be omitted.

There are various types of deterioration factors such as a vibration and a current in addition to the temperature. For example, the threshold information 110 in a case in which the deterioration factor is a vibration is information in which a frequency is used as each threshold, and information indicating the vibration (for example, “Acc”) is registered in the above-described parameter. In addition, the threshold information 110 in a case in which the deterioration factor is a current is information in which a current value is set as each threshold, and information (for example, “I”) indicating a current is registered in the above-described parameter.

### Acceleration Coefficient DB 320

An Acceleration Coefficient Database (DB) 320 Is a database that stores an acceleration coefficient that affects a deterioration speed of the electronic device according to an operating state. The acceleration coefficient varies depending on the operating environment (a temperature state or a vibration state) of the electronic device. Therefore, each threshold classification of the electronic device and the corresponding acceleration coefficient are stored in the acceleration coefficient DB 320 in association with each other.

### Failure Rate DB 330

The failure rate database (DB) 330 is a database that stores a failure rate (reference failure rate) of the electronic device. The failure rate is a frequency at which the electronic device fails, and is represented by the number of failures per unit time. The failure rate DB 330 stores a failure rate corresponding to each electronic device.

### Device Configuration DB

A device configuration database (DB) 340 is a database that stores configuration information (the device configuration information 120) of an electronic device mounted on each edge device. Since the device configuration information 120 is the same as the device configuration information 120 stored in the memory resource 30 of the edge-side processor system 100, a detailed description thereof will be omitted.

### Operation History Management DB 350

The operation history management database (DB) 350 is a database that stores the operation history management information. In the operation history management information, an operation time and a remaining life of the electronic device under each environment such as a standard environment or a stress environment are registered. Details of the operation history management information will be described later.

### Feature Value Management DB 360

The feature value management database (DB) 360 is a database that stores feature values calculated by the server-side processor system 300 and the edge-side processor system 100. Details of the processing related to the feature value will be described later in the third embodiment.

### Temperature Profile DB 370

The temperature profile database (DB) 370 is a database that stores temperature profiles. The temperature profile includes, for example, temperature transition of the electronic device according to the weather and the operation status during the operation in the area where the edge device is operating. Details of the processing using the temperature profile will be described in the fourth embodiment to be described later.

### Cumulative Failure Rate Calculation Program 410

The cumulative failure rate calculation program 410 calculates the cumulative failure rate of the electronic device using the operation history information. Details of the calculation process of the cumulative failure rate will be described later.

Operation History Management Program 420 The operation history management program 420 executes the generation processing of the operation history management information and generates the operation history management information. Specifically, the operation history management program 420 generates the operation history management information including the cumulative operation time and the remaining life of each of the standard environment and the stress environment. Details of the generation processing of the operation history management information will be described later.

### Feature Value Comparison Program 430

The Feature Value Comparison Program 430 Compares a feature value calculated by the edge-side processor system 100 with a feature value calculated by the server-side processor system 300, and detects tampering of the operation history when the tampering is present. Details of comparison processing of the feature value will be described later in the third embodiment.

An example of the configuration of the server-side processor system 300 is described above.

### First Embodiment Hereinafter, a first embodiment of the present system will be described.

### Outline of Processing of Present System

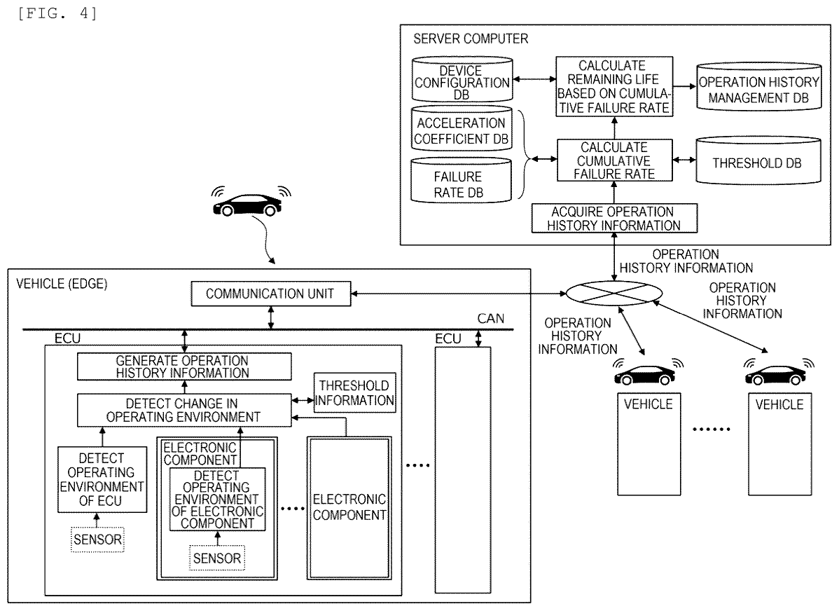

FIG. 4 is a diagram showing an outline example of processing of the present system.

As shown, the edge-side processor system 100 acquires the sensor information (the sensor value indicating the temperature) from the temperature sensor, and determines whether the operating environment of the electronic device exceeds a threshold based on a comparison between the latest sensor value and the previous sensor value. When determining that the operating environment exceeds the threshold, the edge-side processor system 100 generates the operation history information including the corresponding threshold ID and transmits the operation history information to the server-side processor system 300.

Also, when the sensor information (a sensor value indicating that the ignition is changed from the OFF state to the ON state or from the ON state to the OFF state) is acquired from a sensor that detects ON/OFF of the ignition of the automobile, the edge-side processor system 100 generates the operation history information including a corresponding threshold ID and transmits the operation history information to the server-side processor system 300.

The server-side processor system 300 calculates the cumulative failure rate of the electronic device using the acquired operation history information, the threshold information 110 of the corresponding deterioration factor in the threshold DB 310, the failure rate of the corresponding electronic device in the failure rate DB 330, and a corresponding acceleration coefficient in the acceleration coefficient DB 320.

The server-side processor system 300 calculates the remaining life of the electronic device using the calculated cumulative failure rate and the product life of the corresponding electronic device in the device configuration DB 340. The server-side processor system 300 generates the operation history management information including the cumulative operation time and the remaining life of each of the standard environment and the stress environment, and stores the operation history management information in the operation history management DB 350.

An outline example of the processing of the present system is described above.

### Details of Processing of Edge-Side Processor System 100

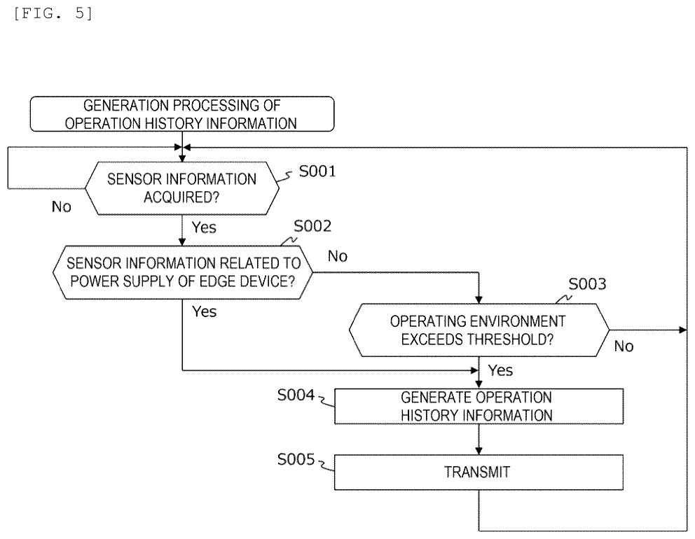

FIG. 5 is a flowchart showing an example of the generation processing of the operation history information. The processing is started, for example, when the edge-side processor system 100 is activated.

When the processing is started, the operation history generation program 210 determines whether sensor information is acquired (step S001). When it is determined that the sensor information is not acquired (No in step S001), the operation history generation program 210 performs the processing of step S001 again. On the other hand, when it is determined that the sensor information is acquired (Yes in step S001), the operation history generation program 210 shifts the processing to step S002.

In step S002, the operation history generation program 210 determines whether the acquired sensor information is sensor information related to a power supply of the edge device. Specifically, the operation history generation program 210 determines whether the acquired sensor information is sensor information indicating that the ignition of the automobile is changed from the OFF state to the ON state or from the ON state to the OFF state.

When it is determined that the sensor information is related to the power supply of the edge device (Yes in step S002), the operation history generation program 210 shifts the processing to step S004. On the other hand, when it is determined that the sensor information is not related to the power supply of the edge device (No in step S002), the operation history generation program 210 shifts the processing to step S003. When the acquired sensor information is not the sensor information related to the power supply of the edge device, the operation history generation program 210 acquires the sensor information (the sensor value indicating the temperature) from the temperature sensor that detects a temperature in the electronic device (ECU).

In step S003, the operation history generation program 210 determines whether the operating environment exceeds a threshold. Specifically, the operation history generation program 210 determines whether the operating environment of the electronic device exceeds any threshold based on the comparison between the latest sensor value and the previous sensor value by using the threshold information 110 and the sensor information (the sensor value indicating the temperature) acquired from the temperature sensor.

When it is determined that the operating environment does not exceed the threshold (No in step S003), the operation history generation program 210 returns the processing to step S001. On the other hand, when it is determined that the operating environment exceeds the threshold (Yes in step S003), the operation history generation program 210 shifts the processing to step S004.

In step S004, the operation history generation program 210 generates the operation history information. Specifically, the operation history generation program 210 identifies a vehicle ID, a device ID, and a threshold ID of the automobile using the device configuration information 120 and the threshold information 110. The operation history generation program 210 generates the operation history information in which a date and time when the sensor information is acquired, the identified vehicle ID, device ID, and threshold ID, and event identification information are associated with each other.

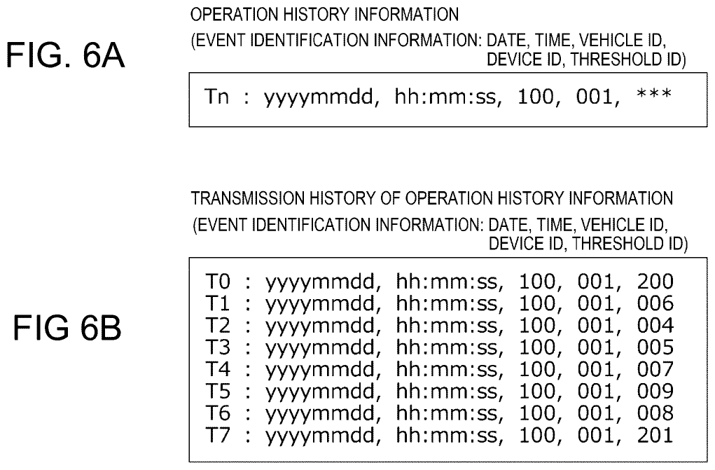

(a) of FIG. 6 is a diagram showing an example of the operation history information. As shown, the operation history information has a simplified configuration in which event identification information (Tn) is associated with the date and time when the sensor information is acquired, the vehicle ID of the automobile, the device ID of the ECU, and the threshold ID.

Next, the operation history generation program 210 transmits the generated operation history information to the server-side processor system 300 (step S005). The operation history generation program 210 returns the processing to step S001 and repeatedly executes the processing of steps S001 to S005.

As described above, the operation history generation program 210 continues to transmit the operation history information to the server-side processor system 300 every time the temperature of the electronic device exceeds the threshold after the power supply of the edge device is in the ON state until the power supply of the edge device is in the OFF state.

(b) of FIG. 6 is a diagram showing an example of a transmission history of the operation history information. The shown transmission history indicates that the operation history information of events T1 to T6 is transmitted to the server-side processor system 300 from an event TO in which the power supply of the electronic device is in the ON state to an event T7 in which the power supply is in the OFF state.

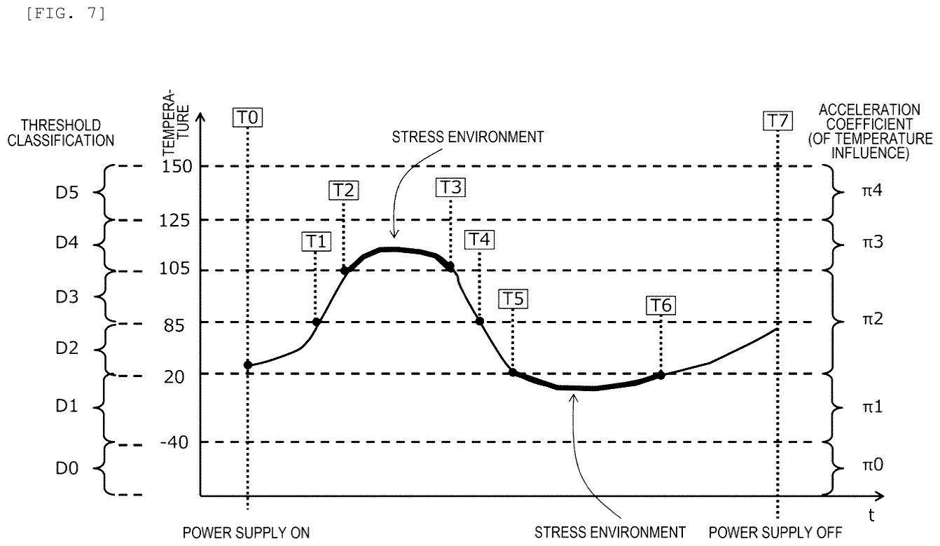

FIG. 7 is a diagram showing an example of a relationship between an event occurrence timing and a change in the operating environment. In the shown example, a horizontal axis represents a time, and a vertical axis represents a temperature in the electronic device (ECU). Each of horizontal broken lines indicates a temperature threshold. Each of areas D0 to D5 classified by each threshold corresponds to a threshold classification. For example, the threshold classification D3 indicated by the area classified by a threshold of 85 °C and a threshold of 105 °C corresponds to a threshold ID “005” or “006” according to a change direction of the operating environment. That is, one threshold classification may be identified by a plurality of threshold IDs. The same applies to the other threshold classifications. The information identifying each threshold classification may be stored in the memory resource 30 in association with, for example, the corresponding threshold ID.

As shown, the events T0 and T7 indicate a time when the power supply of the edge device is in the ON state and a time when the power supply of the edge device is in the OFF state. The event T1 indicates a time when the operating environment changes from lower than 85 °C to 85 °C or higher with reference to 85 °C, which is one of the thresholds. The threshold classification in this case corresponds to D3.

Similarly, an event T2 indicates a time when the operating environment changes from lower than 105 °C to 105 °C or higher with reference to 105 °C, which is one of the thresholds. The threshold classification in this case corresponds to D4. An event T3 indicates a time when the operating environment changes from 105 °C or higher to lower than 105 °C with reference to 105 °C, which is one of the thresholds. The threshold classification in this case corresponds to D3.

An event T4 indicates a time when the operating environment changes from 85 °C or higher to lower than 85 °C with reference to 85 °C, which is one of the thresholds. The threshold classification in this case corresponds to D2. In addition, an event T5 indicates a time when the operating environment changes from 20 °C or higher to lower than 20 °C with reference to 20 °C, which is one of the thresholds. The threshold classification in this case corresponds to D1. An event T6 indicates a time when the operating environment changes from lower than 20 °C to 20 °C or more with reference to 20 °C, which is one of the thresholds. The threshold classification in this case corresponds to D2.

As shown in the threshold information 110 of FIG. 2, the electronic device (ECU) of the present example operates under a stress environment between the events T2 and T3 and the events T5 and T6, and operates under a standard environment between other events.

π0 to π4 indicate acceleration coefficients of a temperature influence, and each of the acceleration coefficients is associated with a predetermined threshold classification. For example, the acceleration coefficient 13 is associated with the threshold classification D4. For example, the acceleration coefficient π2 is associated with both the threshold classifications D3 and D2.

Details of the processing of the edge-side processor system 100 are described above.

### Details of Processing of Server-Side Processor System 300

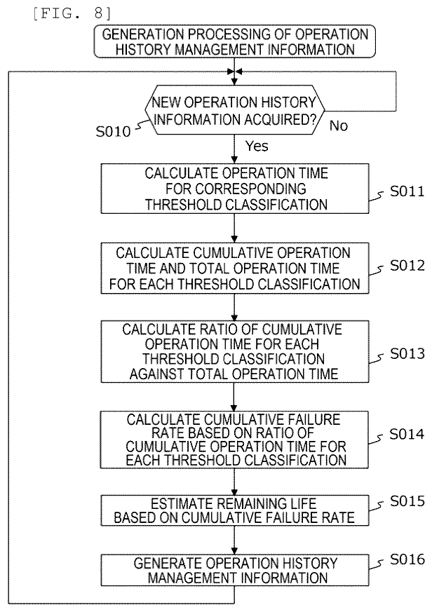

FIG. 8 is a flowchart showing an example of the generation processing of the operation history management information. The processing is started, for example, when operation history information indicating that the power supply of the edge device is in the ON state is acquired.

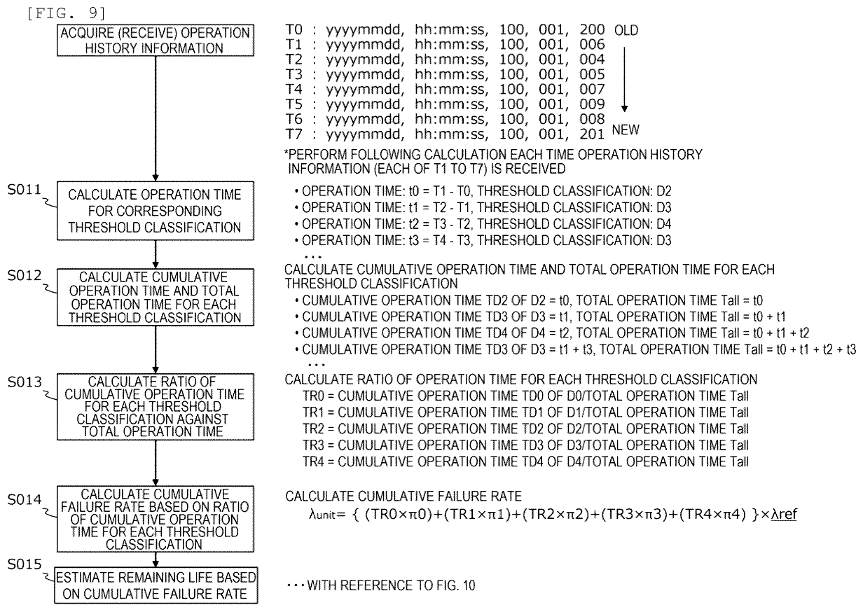

FIG. 9 is a diagram showing an example of specific calculation contents in the generation processing of the operation history management information. Hereinafter, the generation processing of the operation history management information will be described in detail with reference to FIGS. 8 and 9.

When the processing is started, the cumulative failure rate calculation program 410 determines whether the operation history information is newly acquired (step S010). Then, when it is determined that the information is not acquired (No in step S010), the cumulative failure rate calculation program 410 performs the processing of step S010 again. On the other hand, when it is determined that the information is acquired (Yes in step S010), the cumulative failure rate calculation program 410 shifts the processing to step S011.

In step S011, the cumulative failure rate calculation program 410 calculates the operation time of the corresponding threshold classification. Specifically, the cumulative failure rate calculation program 410 identifies a corresponding predetermined threshold classification based on the threshold ID included in the operation history information. In addition, the cumulative failure rate calculation program 410 calculates the operation time of the identified threshold classification based on a difference in an event occurrence time using the latest operation history information and the previously acquired operation history information.

More specifically, in the example, the operation time t0 of the threshold classification D2 is calculated by T1-T0. Similarly, the operation times t1, t2, and t3 of the threshold classifications D3 and D4 are calculated by T2-T1, T3-T2, and T4-T3, respectively.

Next, the cumulative failure rate calculation program 410 calculates the cumulative operation time and a total operation time of each threshold classification (step S012). When there are a plurality of operation times (t1 and t3 in the shown example) as in the threshold classification D3, a value obtained by summing the operation times is the operation time of the threshold classification.

The total operation time Tall is calculated by the total sum of the operation times tn up to that time, such as t0, t1, t2, and t3.

Next, the cumulative failure rate calculation program 410 calculates a ratio of the cumulative operation time of the threshold classification to the total operation time (hereinafter, may be referred to as an “individual operation time ratio”) for each threshold classification (step S013). Specifically, the cumulative failure rate calculation program 410 calculates a ratio TR0 of the cumulative operation time of the threshold classification D0 to the total operation time by a formula cumulative operation time TD0 of D0/total operation time Tall.

Similarly, the Cumulative Failure Rate Calculation program 410 calculates the ratios TR1 to TR4 of the cumulative operation times of the threshold classifications D1 to D4 to the total operation time by the formula of cumulative operation times TD1 to TD4 of D1 to D4/total operation time Tall.

Next, the cumulative failure rate calculation program 410 calculates the cumulative failure rate based on the ratio of the cumulative operation time of each threshold classification (step S014). Specifically, the cumulative failure rate calculation program 410 calculates a cumulative failure rate λunit of the electronic device based on the multiplication of a total sum of values obtained by multiplying the acceleration coefficients corresponding to the individual operation time ratios and a failure rate λref of the electronic device. The failure rate λref is a failure rate of the electronic device stored in the failure rate DB 330.

Next, the cumulative failure rate calculation program 410 estimates (calculates) the remaining life of the electronic device (step S015). Specifically, the cumulative failure rate calculation program 410 identifies the product life of the corresponding electronic device based on the device configuration DB 340, for example, and calculates the remaining life of the electronic device based on comparison with the cumulative failure rate.

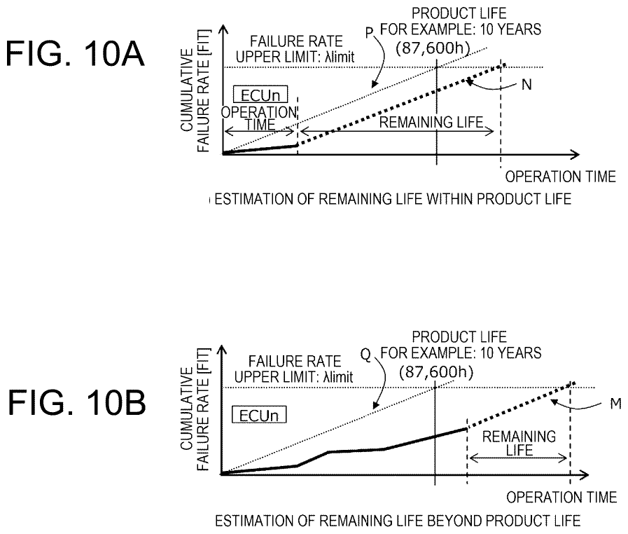

(a) of FIG. 10 is a diagram showing an estimation graph of the remaining life within the product life. (b) of FIG. 10 is a diagram showing an estimation graph of the remaining life after the product life. In (a) and (b) of FIG. 10, a horizontal axis represents the operation time of the electronic device, and a vertical axis represents the cumulative failure rate calculated in step S014. In the example, 10 years are assumed as the product life due to a standard use, and it is shown that the cumulative failure rate reaches an upper limit λlimit of the failure rate when 10 years elapse.

In the example of (a) of FIG. 10, the cumulative failure rate with respect to the operation time is lower than that in the standard use, and the operation time in the stress environment is short. In this case, it is estimated that the electronic device has a remaining life corresponding to the operation time indicated by a broken line N. The broken line N indicating an increasing tendency of the cumulative failure rate in a remaining life period may be set to, for example, the same slope as a line P indicating an increasing tendency of the cumulative failure rate assumed in the standard use.

In the example of (b) of FIG. 10, although the operation time exceeds the product life, similarly to the case of (a) of FIG. 10, the cumulative failure rate with respect to the operation time is lower than that in the standard use, and the operation time in the stress environment is short. In this case, it is estimated that the electronic device has a remaining life corresponding to the operation time indicated by a broken line M. Similarly to the broken line N, the broken line M is set to have the same slope as a line Q indicating the increasing tendency of the cumulative failure rate assumed in the standard use.

Next, the Operation History Management Program 420 generates the operation history management information (step S016). Specifically, the operation history management program 420 generates the operation history management information including a vehicle ID of an automobile that is the edge device, a device ID of a target electronic device, an operation time in each of the standard environment and the stress environment, and a remaining life.

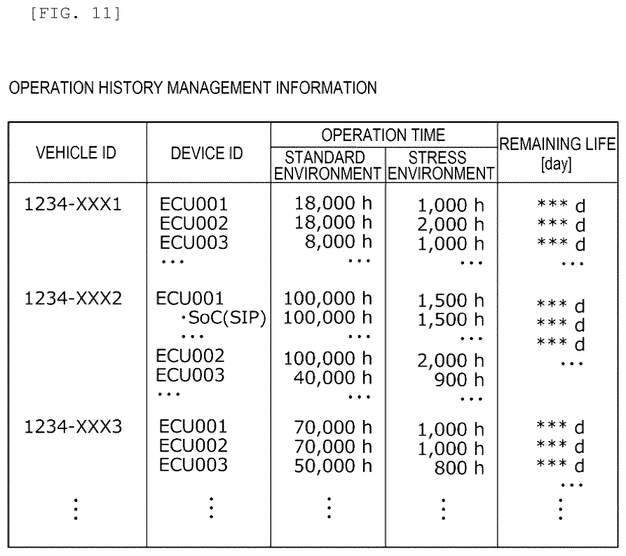

FIG. 11 is a diagram showing an example of the operation history management information. The operation history management program 420 identifies, for example, the vehicle ID and the device ID based on the operation history information. The operation history management program 420 calculates the cumulative operation time of the standard environment and the stress environment based on the threshold information 110 and the cumulative operation time of each threshold classification calculated in step S012. In addition, the operation history management program 420 generates (updates) the operation history management information including the vehicle ID, the device ID, the cumulative operation time of the standard environment, the cumulative operation time of the stress environment, and the remaining life estimated in step S015.

After performing the processing of step S016, the operation history management program 420 returns the processing to step S010 again.

When the power supply of the edge device is in the OFF state and then the power supply is in the ON state, the operation time, the cumulative operation time, and the total operation time in each threshold classification are taken over, and the operation time or the like after the power supply is in the ON state is added based on these times.

An example of the configuration of the server-side processor system 300 is described above.

According to the present system, it is possible to manage the operation history of the electronic device or the like using the state data in which the communication amount is further reduced. In particular, the operation history information transmitted from the edge-side processor system to the server-side processor system is simplified by representing the operating environment of the electronic device or the like using the threshold classification, and the data amount thereof is reduced. Since the operation history information is transmitted to the server-side processor system only at the time of generation, the number of communications is reduced. Therefore, in the present system, it is possible to contribute to a reduction in the communication amount between the edge device and the server computer and the accompanying communication cost.

According to the present system, it is possible to manage information indicating how long the electronic device or the like is operated in each of the standard environment and the stress environment, and the remaining life of the device.

### Second Embodiment

Next, a second embodiment of the present system will be described. The system according to the second embodiment calculates a remaining life of an electronic device based on a cumulative failure rate calculated in consideration of a plurality of deterioration factors. Specifically, in the second embodiment, calculation of the cumulative failure rate and the remaining life when the deterioration factor is a temperature and a vibration will be described. Hereinafter, differences from the first embodiment will be mainly described, and a detailed description of the same configuration and processing will be omitted.

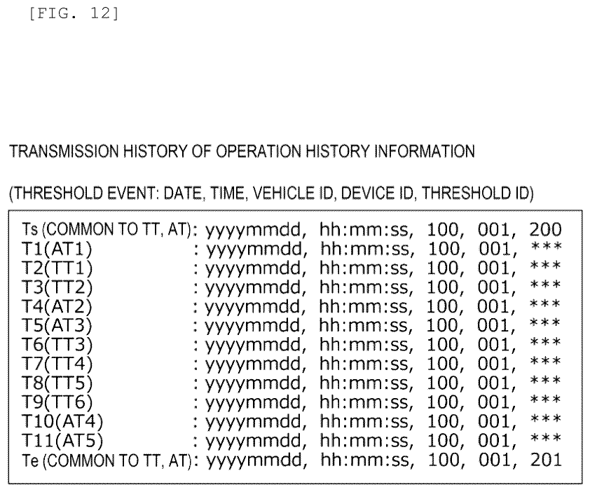

FIG. 12 is a diagram showing an example of a transmission history of operation history information according to the present embodiment. The shown transmission history indicates that the operation history information of events T1 to T11 is transmitted to the server-side processor system 300 between an event Ts in which the power supply of the electronic device is in the ON state and an event Te in which the power supply is in the OFF state. TT indicates an event when the deterioration factor is a temperature, and AT indicates an event when the deterioration factor is a vibration.

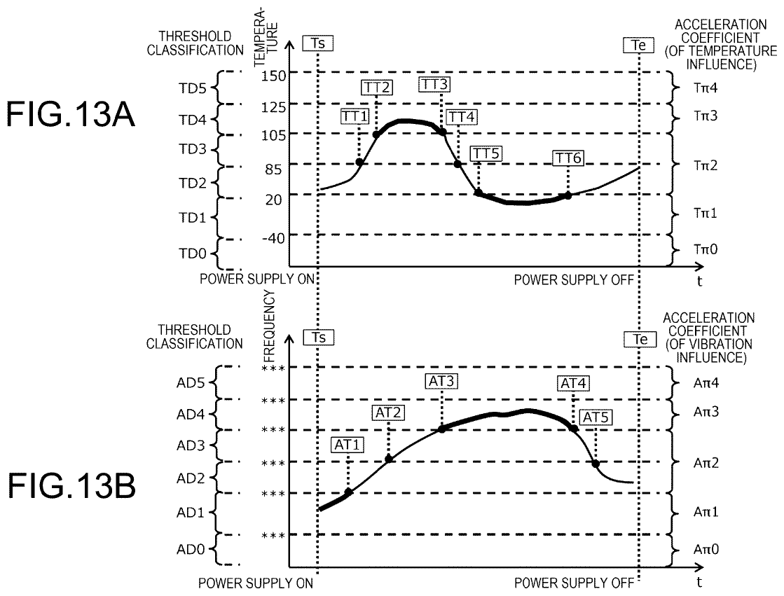

(a) of FIG. 13 is a diagram showing an example of a relationship between an event occurrence timing and a change in an operating environment when the deterioration factor is the temperature. (b) of FIG. 13 is a diagram showing an example of the relationship between the event occurrence timing and the change in the operating environment when the deterioration factor is a vibration.

In these drawings, the threshold classifications when the deterioration factor is the temperature are indicated by TDO to TD5, and the threshold classifications when the deterioration factor is the vibration are indicated by ADO to AD5. Acceleration coefficients of the temperature influence are indicated by Tπ0 to Tπ4, and acceleration coefficients of the vibration influence are indicated by Aπ0 to Aπ4.

When calculating the cumulative failure rate of the electronic device in consideration of a plurality of deterioration factors, the cumulative failure rate calculation program 410 performs the processing of steps S011 to S014 for each deterioration factor.

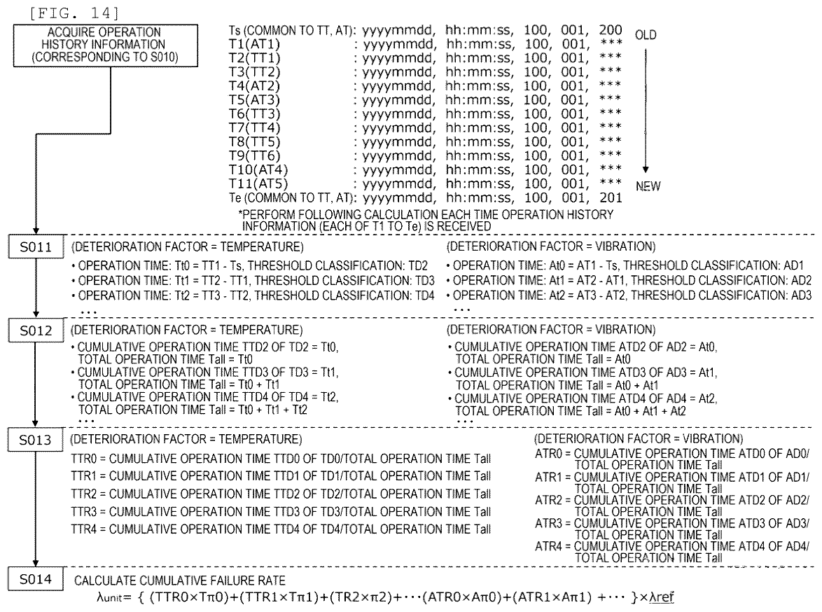

FIG. 14 is a diagram showing an example of specific calculation contents of the cumulative failure rate in the generation processing of the operation history management information. Steps S011 to S014 shown in the drawing correspond to step numbers in the above-described generation processing of the operation history management information.

As shown in the drawing, the cumulative failure rate calculation program 410 separately calculates the individual operation time ratio for each of the case in which the deterioration factor is the temperature and the case in which the deterioration factor is the vibration.

In step S014, the cumulative failure rate calculation program 410 calculates the cumulative failure rate Aunit of the electronic device by multiplying the failure rate Aref of the electronic device by a value obtained by adding the total sum of the values obtained by multiplying the acceleration coefficients corresponding to the individual operation time ratios when the deterioration factor is the temperature and the total sum of the values obtained by multiplying the acceleration coefficients corresponding to the individual operation time ratios when the deterioration factor is the vibration.

In step S015, the cumulative failure rate calculation program 410 estimates the remaining life of the electronic device based on the cumulative failure rate. In step S016, the cumulative failure rate calculation program 410 generates the operation history management information including the estimated remaining life, the cumulative operation time in the standard environment, and the cumulative operation time in the stress environment.

The deterioration factor is not limited to the temperature or the vibration, and for example, there is another deterioration factor such as a current, and for example, even when the cumulative failure rate or the remaining life is calculated in consideration of three or more deterioration factors, the cumulative failure rate or the remaining life can be calculated by performing calculation in the same manner as in the present embodiment.

The second embodiment of the present system is described above.

According to the present system, the remaining life of the electronic device can be estimated in consideration of a plurality of deterioration factors. Therefore, according to the present system, it is possible to more accurately estimate the remaining life of the electronic device and generate and manage highly reliable operation history management information.

### Third Embodiment

Next, a third embodiment of the present system will be described. The present system according to the third embodiment detects a tampering of the operation history based on the feature value calculated by the edge-side processor system 100 and the server-side processor system 300 using the operation history management information and the operation history information. Hereinafter, differences from the first embodiment and the second embodiment will be mainly described, and a detailed description of the same configuration and processing will be omitted.

### Feature Value Calculation Processing

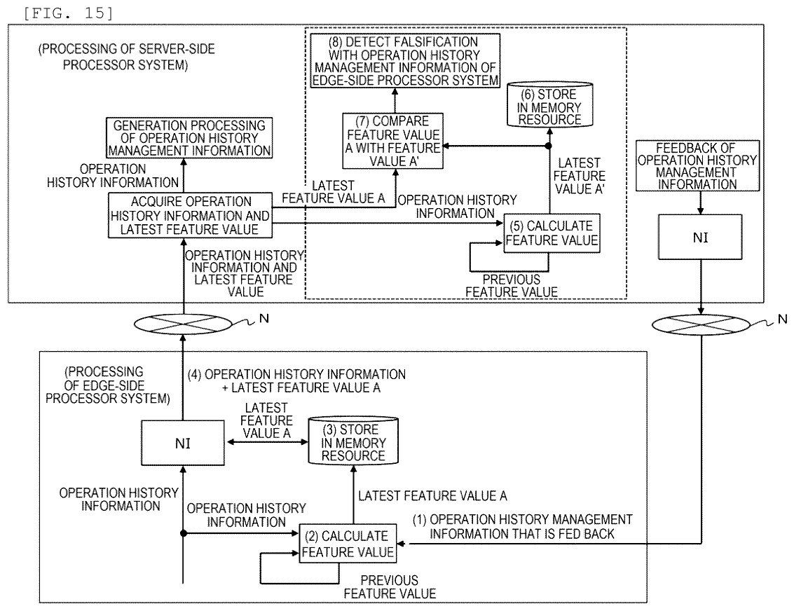

Processing of Edge-Side Processor System 100 FIG. 15 is a diagram showing an outline example of the feature value calculation processing. As shown, the feature value calculation program 220 of the edge-side processor system 100 acquires, from the server-side processor system 300, feedback of operation history management information for its own edge device (1). The feature value calculation program 220 acquires the latest operation history information generated by the operation history generation program 210. The feature value calculation program 220 calculates a feature value using the operation history management information and the operation history information (2). As a method for calculating the feature value, for example, a stream cipher (for example, LFSR: linear feedback shift register) or a one-way hash function (for example, an algorithm such as SHA512) may be used.

Such feature value calculation processing performed by the edge-side processor system 100 may be executed, for example, at a timing when the latest operation history information is acquired after the feedback of the operation history management information is received from the server-side processor system 300. The feedback of the operation history management information may be executed periodically (for example, during activation of the edge-side processor system 100, at a predetermined time, every several hours, or every several days).

A calculated latest feature value A includes both the feature value calculated using the operation history management information and the latest operation history information and the feature value calculated from the value obtained by combining the latest operation history information with the feature value calculated in the previous feature value calculation processing.

The feature value calculation program 220 stores the calculated latest feature value A in the memory resource 30 (3) and transmits the feature value A to the server-side processor system 300 together with the latest operation history information.

Although the latest feature value is stored in the memory resource 30, feature values for a plurality of times may be stored.

The feature value calculation processing performed by the edge-side processor system 100 is described above.

### Processing of Server-Side Processor System 300

Next, the feature value comparison program 430 of the server-side processor system 300 calculates a feature value A′ by the same method (algorithm) as the method for calculating the feature value by the feature value calculation program 220 of the edge-side processor system 100, using the latest operation history information acquired from the edge-side processor system 100 and the operation history management information fed back to the edge-side processor system 100 (5). It is assumed that the calculated feature value A′ includes a feature value of a type corresponding to the feature value included in the feature value A.

Next, the feature value comparison program 430 stores the calculated latest feature value A′ in the memory resource 30 (6), and compares the feature value A with the feature value A′ (7). When the feature value A and the feature value A′ indicate different values, the feature value comparison program 430 detects that the operation history management information fed back to the edge-side processor system 100 is falsified (8).

The third embodiment of the present system is described above.

According to the present system, when the tampering is detected, for example, it is possible to take various measures such as removing the edge device from a management target of an operation history or proposing replacement of an electronic device to a user of the edge device.

In particular, when the electronic device is replaced with another edge device at the time of reuse and secondary use, a management source of the edge device is changed. The tampering of the operation history often occurs at the timing of such replacement of the electronic device. In particular, the tampering of the operation history is often performed for the purpose of appealing that a sufficient remaining life of the electronic device subjected to the reuse and secondary use remains. According to the present system, by detecting the tampering of the operation history, for example, it is possible to provide merits for a product user of reuse and secondary use, such as notifying the product user of the tampering or proposing replacement of the electronic device.

### Fourth Embodiment

Next, a fourth embodiment of the present system will be described. In an environment or a specification in which the operation history information cannot be acquired from the edge-side processor system 100, a system according to the fourth embodiment estimates an operating environment of the electronic device using weather information and a temperature profile to calculate the remaining life. Hereinafter, differences from the first embodiment to the third embodiment will be mainly described, and a detailed description of the same configuration and processing will be omitted.

### Calculation Processing of Remaining Life Using Temperature Profile

First, the position information output program 230 of the edge-side processor system 100 periodically (for example, every few minutes or every few hours) calculates position information for identifying a current position of the edge device using output information from the GPS reception device 80, and transmits the position information to the server-side processor system 300.

The cumulative failure rate calculation program 410 of the server-side processor system 300 acquires the weather information in a region from a predetermined weather information distribution service based on the position information acquired from the edge-side processor system 100. In addition, the cumulative failure rate calculation program 410 identifies, using the temperature profile, a transition of a temperature environment of the electronic device corresponding to the acquired weather condition such as the weather in the region.

Accordingly, the cumulative failure rate calculation program 410 can estimate a temperature transition of the electronic device as shown in FIG. 7, for example. That is, the cumulative failure rate calculation program 410 can estimate information having a content same as that of the operation history information related to the temperature.

In addition, the cumulative failure rate calculation program 410 calculates the cumulative failure rate and the remaining life of the electronic device by executing the above-described generation processing of the operation history management information, based on the estimated temperature transition.

The fourth embodiment of the present system is described According to the present system, even when the operation history information cannot be acquired from the edge-side processor system 100, information having the content same as that of the operation history information can be estimated based on the weather information and the temperature profile. As a result, the present system can estimate the cumulative failure rate and the remaining life of the electronic device even when the operation history information cannot be acquired.

### Service Form of Present System

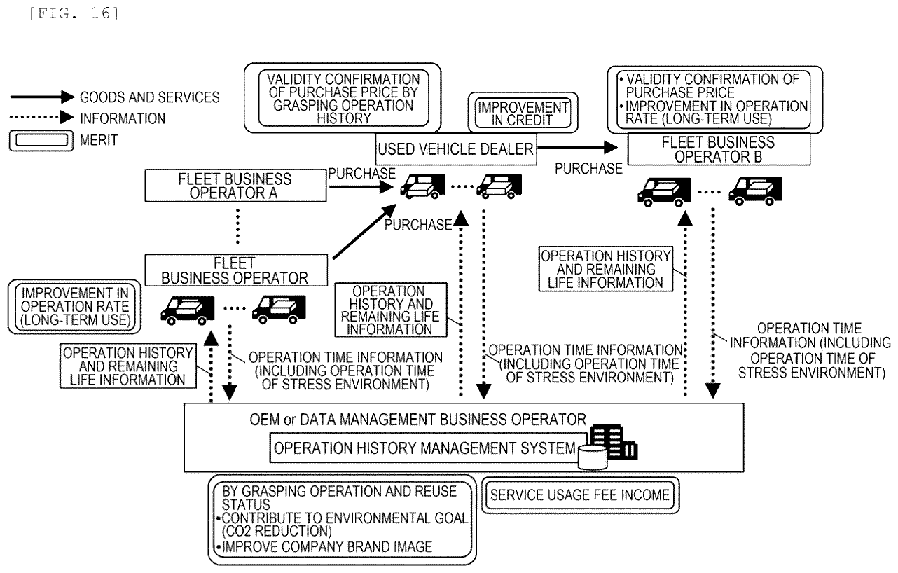

FIGS. 16 to 18 are diagrams showing an example of a service form to which the present system is applied.

FIG. 16 is a diagram showing an example of a service form for a fleet business operator or a used vehicle dealer. The shown operation history management system corresponds to the present system. The present system is held, managed, and operated by an edge device manufacturing company (in the shown example, described as OEM: original equipment manufacturer) or a data management business operator.

In the service, a data management business operator or the like provides a fleet business operator (a business operator who owns and manages a large number of edge devices) or a used vehicle dealer with an operation history (operation history management information including a remaining life, an operation time under a stress environment, and the like) of an electronic device for a fee. Accordingly, the data management business operator or the like can obtain an income based on a usage fee of the service.

In addition, the data management business operator or the like can obtain the merits of contributing to an environmental goal (reduction of CO2 or the like) by contributing to prevention of disposal of the electronic device not reaching the product life by grasping an operation and a reuse status. The data management business operator can obtain a merit of improving a brand image as a company based on social contribution.

A fleet business operator A can obtain a merit of improving an operation rate of the edge device with long-term use of the electronic device.

In addition, when purchasing a vehicle from the fleet business operator A, the used vehicle dealer can obtain a merit that validity of a purchase price can be confirmed based on the grasp of the operation history. In addition, since the used vehicle dealer can grasp the product life, the operation time under a stress environment, and the like of the electronic device mounted on a target vehicle based on the operation history, the electronic device having a high possibility of failure can be replaced before sales. Accordingly, the used vehicle dealer can obtain a merit of improving credit to the user of a dealer and a fleet business operator B.

In addition, the fleet business operator B who purchases the vehicle from the used vehicle dealer can obtain a merit that the validity of the purchase price can be confirmed based on the grasp of the operation history. The fleet business operator B can obtain a merit of improving the operation rate of the edge device with long-term use of the electronic device.

As described above, the present system can provide many merits to stakeholders such as a data management business operator, a fleet business operator, and a used vehicle dealer.

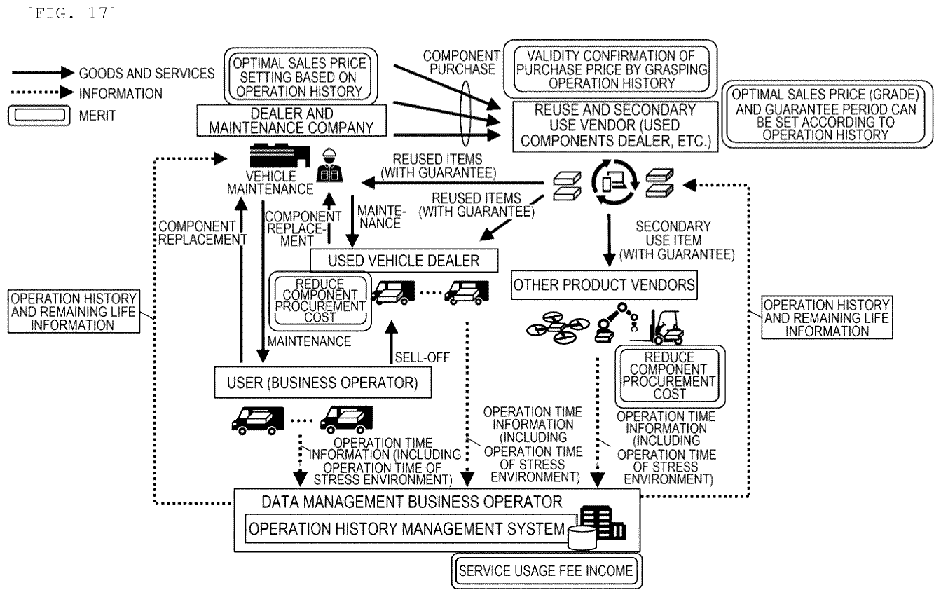

FIG. 17 is a diagram showing an example of a service form for a reuse and secondary use vendor. In the service, a data management business operator provides a service for paying for an operation history (operation history management information including a remaining life, an operation time under a stress environment, and the like) of an electronic device to a reuse and secondary use vendor or a dealer and maintenance company. Accordingly, the data management business operator can obtain a merit of obtaining an income based on the usage fee of the service.

The reuse and secondary use vendor can obtain a merit that an optimal sales price and guarantee period can be set according to the operation history. The reuse and secondary use vendor can obtain a merit that the validity of the purchase price can be confirmed when purchasing the electronic device from the dealer and maintenance company based on the grasp of the operation history.

In addition, the dealer and maintenance company can obtain a merit that an optimal sales price according to the operation history can be set. In addition, the used vehicle dealer and other product vendors can obtain a merit that component procurement cost from the reuse and secondary use vendors can be reduced.

As described above, the present system can provide many merits to stakeholders such as a data management business operator, a reuse and secondary use vendor, a dealer and maintenance company, a used vehicle dealer, and other product vendors.

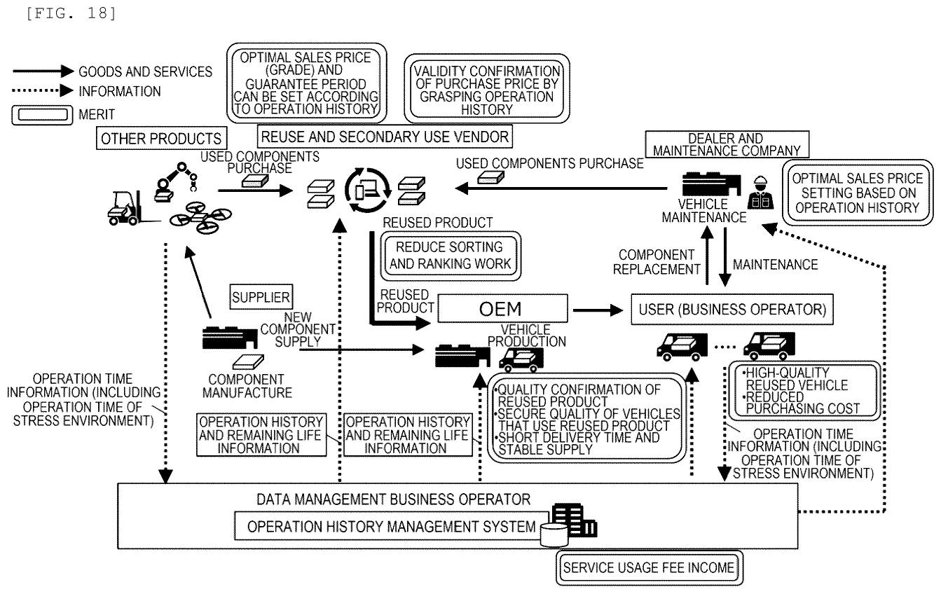

FIG. 18 is a diagram showing an example of a service form for a manufacturing company (OEM) or a reuse and secondary use vendor. In the service, a data management business operator provides a service for paying for an operation history (operation history management information including a remaining life, an operation time under a stress environment, and the like) of an electronic device to a reuse and secondary use vendor, a dealer and maintenance company, a manufacturing company (OEM), and a user (business operator). Accordingly, the data management business operator can obtain a merit of obtaining an income based on the usage fee of the service.

The reuse and secondary use vendor can obtain a merit that the validity of the purchase price of the used electronic device (including the electronic component) can be confirmed from the dealer and maintenance company by the grasp of the operation history. The reuse and secondary use vendor can obtain a merit that the optimal sales price and the guarantee period can be set according to the operation history. In addition, the reuse and secondary use vendor can obtain a merit that it is possible to reduce man-hours for sorting and ranking used electronic devices (including electronic components) purchased based on the grasp of the operation history.

In addition, the dealer and maintenance company can obtain a merit that an optimal sales price according to the operation history can be set. The user (business operator) can obtain a merit that a high-quality reused vehicle can be owned based on the grasp of the operation history. The user (business operator) can obtain a merit that the purchase cost can be reduced based on the grasp of the operation history.

The manufacturing company (OEM) can obtain a merit that the quality of the reused product can be confirmed based on the grasp of the operation history. The manufacturing company can obtain a merit of securing the quality of the vehicle using the reused product. The manufacturing company can obtain merits of short delivery and stable supply.

As described above, the present system can provide many merits to stakeholders such as a data management business operator, a reuse and secondary use vendor, a dealer and maintenance company, a manufacturing company (OEM), and a user (business operator).

The service form of the present system is described above.

The computer related to the edge-side processor system 100 and the server-side processor system 300 may function at least as a program distribution server that distributes the program in the memory resource 30 (31) to another computer such that the program can be executed by another computer.

The invention is not limited to the above-described embodiments and modifications, and includes various modifications within the scope of the same technical idea. For example, the above embodiments have been described in detail to facilitate understanding of the invention, and the invention is not necessarily limited to those including all the configurations described above. A part of a configuration of a certain embodiment can be replaced with a configuration of another embodiment, and a configuration of another embodiment can be added to a configuration of a certain embodiment. It is possible to add, delete, or replace a part of configurations of each embodiment with other configurations.

In the above description, control lines and information lines considered to be necessary for description are shown, and not all control lines and information lines in a product are necessarily shown. Actually, almost all configurations may be considered to be connected to one another.

### REFERENCE SIGNS LIST

100: edge-side processor system
20: processor
30: memory resource
40: network interface device (NI)
60: various sensors
70: CAN
80: GPS reception device
110: threshold information
120: device configuration information
130: feature value information
210: operation history generation program
220: feature value calculation program
230: position information output program
300: server-side processor system
21: processor
31: memory resource
41: network interface device (NI)
51: user interface device (UI)
310: threshold DB
320: acceleration coefficient DB
330: failure rate DB
340: device configuration DB
350: operation history management DB
360: feature value management DB
370: temperature profile DB
410: cumulative failure rate calculation program
420: operation history management program
430: feature value comparison program
10 (11): external device
N: communication network

1. A system comprising:
an edge-side processor system that is mounted on an edge device and that includes a processor and a memory resource; and
a server-side processor system that is communicable with the edge-side processor system, that is mounted on a server computer, and that includes a processor and a memory resource, wherein
the memory resource of the edge-side processor system stores at least threshold information in which a threshold corresponding to a predetermined deterioration factor that shortens a period until a failure of an electronic device or an electronic component is registered, and an operation history generation program,
by executing the operation history generation program, the processor of the edge-side processor system
generates operation history information including a threshold ID for identifying the threshold when an operating environment of the electronic device or the electronic component exceeds the threshold, and
transmits the generated operation history information to the server-side processor system,
the memory resource of the server-side processor system stores at least a cumulative failure rate calculation program and an operation history management program,
by executing the cumulative failure rate calculation program, the processor of the server-side processor system
calculates, for each threshold classification corresponding to the threshold ID, a cumulative operation time under each of operating environments to a total operation time of the electronic device or the electronic component,
calculates a cumulative failure rate the electronic device or the electronic component based on the cumulative operation time, and
estimates a remaining life of the electronic device or the electronic component based on the cumulative failure rate and a product life, and
by executing the operation history management program, the processor of the server-side processor system
generates operation history management information including the remaining life and the cumulative operation time under at least a stress environment among the operating environments.

2. The system according to claim 1, wherein
the threshold information includes at least a threshold corresponding to the deterioration factor and the threshold ID indicating the operating environment of the electronic device or the electronic component classified into the threshold.

3. The system according to claim 2, wherein
the threshold ID is associated with a standard environment and the stress environment as types of the operating environment corresponding to the threshold classification.

4. The system according to claim 1, wherein
by executing the cumulative failure rate calculation program, the processor of the server-side processor system
calculates a ratio of the cumulative operation time under the operating environment to the total operation time of the electronic device or the electronic component for each of the threshold classifications, and
calculates the cumulative failure rate by multiplying a total sum of values obtained by multiplying each of the ratios of the cumulative operation time under the operating environment calculated for each of the threshold classifications by an acceleration coefficient of the deterioration factor corresponding to the threshold classification by a standard failure rate of the electronic device or the electronic component.

5. The system according to claim 4, wherein
by executing the cumulative failure rate calculation program, the processor of the server-side processor system
estimates the remaining life based on a comparison between the cumulative failure rate of the electronic device or the electronic component and an upper limit value of the cumulative failure rate corresponding to the product life.

6. The system according to claim 1, wherein
the memory resource of the server-side processor system further stores the threshold information corresponding to each of a plurality of the deterioration factors, and
by executing the cumulative failure rate calculation program, the processor of the server-side processor system
calculates the cumulative operation time for each of the deterioration factors using the threshold information corresponding to each of the deterioration factors,
calculates the cumulative failure rate of the electronic device or the electronic component based on a total sum of the cumulative operation times for each of the deterioration factors, and
estimates the remaining life of the electronic device or the electronic component based on the cumulative failure rate and the product life.

7. The system according to claim 6, wherein the plurality of deterioration factors include at least a temperature, a vibration, and a current.

8. The system according to claim 1, wherein
the memory resource of the edge-side processor system further stores a feature value calculation program, and
by executing the feature value calculation program, the processor of the edge-side processor system
calculates a feature value using the operation history management information fed back from the server-side processor system and the operation history information, and
transmits the calculated feature value and the operation history information to the server-side processor system,
the memory resource of the server-side processor system further stores a feature value comparison program, and
by executing the feature value calculation program, the processor of the server-side processor system
calculates a feature value using the operation history management information fed back to the edge-side processor system and the operation history information, and
detects a tampering of the operation history management information in the edge-side processor system by comparing the calculated feature value with the feature value calculated by the edge-side processor system.

9. The system according to claim 8, wherein
the feature value includes
a feature value calculated using the operation history management information and the operation history information, and a feature value calculated based on a value obtained by combining the operation history information with the feature value calculated in previous processing.

10. The system according to claim 1, wherein
the memory resource of the edge-side processor system further stores a position information output program,
by executing the position information output program, the processor of the edge-side processor system
transmits, to the server-side processor system, position information of an edge device on which the edge-side processor system is mounted,
the memory resource of the server-side processor system further stores temperature profile information including a profile condition related to weather in a region where the edge device is operating and a temperature transition of the electronic device measured under the profile condition,
by executing the cumulative failure rate calculation program, the processor of the server-side processor system
estimates a temperature transition of a temperature environment of the electronic device or the electronic component based on a correspondence between the weather in the region corresponding to the position information of the edge device and the temperature transition, and
estimates the cumulative failure rate and the remaining life of the electronic device or the electronic component based on the temperature transition.

11. An operation history management method performed by a system including
an edge-side processor system that is mounted on an edge device and that includes a processor and a memory resource, and
a server-side processor system that is communicable with the edge-side processor system, that is mounted on a server computer, and that includes a processor and a memory resource, the method comprising:
a step of storing, by the memory resource of the edge-side processor system, at least threshold information in which a threshold corresponding to a predetermined deterioration factor that shortens a period until a failure of an electronic device or an electronic component is registered, and an operation history generation program;
steps performed by the processor of the edge-side processor system executing the operation history generation program, the steps including
generating operation history information including a threshold ID for identifying the threshold when an operating environment of the electronic device or the electronic component exceeds the threshold, and
transmitting the generated operation history information to the server-side processor system;
a step of storing, by the memory resource of the server-side processor system, at least a cumulative failure rate calculation program and an operation history management program;
steps performed by the processor of the server-side processor system executing the cumulative failure rate calculation program, the steps including
calculating, for each threshold classification corresponding to the threshold ID, a cumulative operation time under each of operating environments to a total operation time of the electronic device or the electronic component,
calculating a cumulative failure rate of the electronic device or the electronic component based on the cumulative operation time, and
estimating a remaining life of the electronic device or the electronic component based on the cumulative failure rate and a product life; and
a step of generating, by the processor of the server-side processor system executing the operation history management program, operation history management information including the remaining life and the cumulative operation time under at least a stress environment among the operating environments.

12. The operation history management method according to claim 11, further comprising:
a step of further storing, by the memory resource of the server-side processor system, the threshold information corresponding to each of a plurality of the deterioration factors; and
steps performed by the processor of the server-side processor system executing the cumulative failure rate calculation program, the steps including
calculating the cumulative operation time for each of the deterioration factors using the threshold information corresponding to each of the deterioration factors,
calculating the cumulative failure rate of the electronic device or the electronic component based on a total sum of the cumulative operation times for each of the deterioration factors, and
estimating the remaining life of the electronic device or the electronic component based on the cumulative failure rate and the product life.

13. The operation history management method according to claim 11, further comprising:
a step of further storing, by the memory resource of the edge-side processor system, a feature value calculation program; and
steps performed by the processor of the edge-side processor system executing the feature value calculation program, the steps including
calculating a feature value using the operation history management information fed back from the server-side processor system and the operation history information, and
transmitting the calculated feature value and the operation history information to the server-side processor system;
a step of further storing, by the memory resource of the server-side processor system,: a feature value comparison program; and
steps performed by the processor of the server-side processor system executing the feature value calculation program, the steps including
calculating a feature value using the operation history management information fed back to the edge-side processor system and the operation history information, and
detecting a tampering of the operation history management information in the edge-side processor system by comparing the calculated feature value with the feature value calculated by the edge-side processor system.

14. The operation history management method according to claim 11, further comprising:
a step of further storing, by the memory resource of the edge-side processor system, a position information output program;
a step of transmitting, by the processor of the edge-side processor system executing the position information output program, to the server-side processor system, position information of an edge device on which the edge-side processor system is mounted;
a step of further storing, by the memory resource of the server-side processor system, temperature profile information including a profile condition related to weather in a region where the edge device is operating and a temperature transition of the electronic device measured under the profile condition;
steps performed by the processor of the server-side processor system executing the cumulative failure rate calculation program, the steps including
estimating a temperature transition of a temperature environment of the electronic device or the electronic component based on a correspondence between the weather in the region corresponding to the position information of the edge device and the temperature transition, and estimating the cumulative failure rate and the remaining life of the electronic device or the electronic component based on the temperature transition.
